(19) United States
(12) Patent Application Publication
(10) Pub. No.: US 2006/0072932 A1
(43) Pub. Date: Apr. 6, 2006

(54) Image forming apparatus for preventing resistance variation of intermediate transfer belt and method thereof

(75) Inventors: Myung-kook Ahn, Suwon-si (KR); In-yong Song, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/238,063

(22) Filed: Sep. 29, 2005

(30) Foreign Application Priority Data
Oct. 4, 2004 (KR) 2004-78679

(51) Int. Cl. G03G 15/16

(52) U.S. Cl. 399/66

(57) ABSTRACT

An image forming apparatus for performing a printing job using an intermediate transfer belt is provided. The image forming apparatus has a voltage determination part for determining a predetermined level of a refresh voltage corresponding to a potential difference which is generated on opposite surfaces of the intermediate transfer belt, and a power supply for supplying the refresh voltage to the intermediate transfer belt so that the potential difference is offset. The power supply supplies the refresh voltage to the intermediate transfer belt through a certain roller which is in contact with the intermediate transfer belt. Accordingly, the potential difference caused by the polarization in the intermediate transfer belt is offset by the refresh voltage, and the variation of the resistance caused by the potential difference is prevented.

### PRIORITY

This application claims the benefit under 35 U.S.C. § 119(a) of Korean Patent Application No. 2004-78679, filed on Oct. 4, 2004, the entire contents of which are incorporated herein by reference.

### BACKGROUND OF THE INVENTION

1. Field of the Invention

The present invention relates to an image forming apparatus which uses an intermediate transfer belt and a method thereof. More particularly, the present invention relates to an image forming apparatus which is capable of preventing a resistance of an intermediate transfer belt from varying by using a refresh voltage supplied to the intermediate transfer belt.

2. Description of the Related Art

With the development of electronic technology, peripherals for computers, such as printers or scanners, are increasingly utilized. While printer manufacturers have invested in development of various printers, laser printers have risen to prominence in recent years. Laser printers have distinguishable advantages over from dot printers or ink-jet printers such has improved print quality, print speed, and noise reduction. Laser printers use a principle that attracts toners to a drum by using laser beams converted into an image signal and fuses the toners to paper with high temperature heats.

The laser printer prints an image through a series of processes, i.e., charging, writing, developing, transferring, and fusing. The charging process supplies a high voltage (approximately 7000V) to a charger and forms a negative (−) electric charge on a surface of the drum by a corona discharge. The writing process scans the surface of the drum, on which the negative (−) electric charge is formed, with laser beams and removes the negative (−) electric charge in the form of text, thereby forming a latent image. The developing process rotates a developing roller and the drum with a predetermined gap therebetween, thereby attracting toner particles having a negative (−) property to the latent image. The transferring process supplies a predetermined transfer voltage to a transferring medium when paper passes between the drum and the transferring medium and forms a positive (+) electric charge on the backside of the paper, thereby transferring the negative (−) toner particles formed on the surface of the drum to the paper. The fusing process applies heat and pressure to a toner image formed on the paper and fuses the toner image onto the paper. Through the above-described processes, an image is formed on the paper and output.

In color printers, toners having the four colors of cyan, magenta, yellow, black are used to obtain a color image. In order to obtain a more vivid color image, four organic photoconductors (OPCs) are used, and printing operations are performed by color toners. Also, the transferring process uses an intermediate transfer belt and performs two steps to output the respective color toners to appropriate positions.

FIG. 1 is a view showing a general image forming apparatus which performs a transferring process by using an intermediate transfer belt and through two steps. Referring to FIG. 1, the image forming apparatus comprises an intermediate transfer belt 10, a pre-cleaning roller 20, a driving roller 25, four first transfer rollers 30, 40, 50, 60, four respective OPCs 35, 45, 55, 65, a second transfer backup roller 70, and a second transfer roller 75.

The driving roller 25 moves the intermediate transfer belt 10 at a proper speed, and the pre-cleaning roller 20 cleans off toners being left on a surface of the intermediate transfer roller 10 before the toners are removed by a cleaning blade 23.

The first transfer rollers 30, 40, 50, 60 correspond to the first to fourth OPCs 35, 45, 55, 65, respectively, and the intermediate transfer belt 10 is located therebetween. Accordingly, the first transfer rollers and the OPCs transfer their respective toners, each having one of black, cyan, magenta, and yellow, respectively, to the intermediate transfer roller 10. That is, toners having colors of black, cyan, magenta, and yellow are attracted to respective ones of the OPCs 35, 45, 55, 65 during the developing process, and then transferred to the intermediate transfer belt 10 by the first transfer rollers 30, 40, 50, 60. In this case, the image forming apparatus recognizes location marks formed on the intermediate transfer belt 10 and synchronizes operations of the OPC 35, 45, 55 and 65 and the first transfer rollers 30, 40, 50, 60 so that one color image is formed.

Meanwhile, when the paper is conveyed in an arrowed direction as shown in FIG. 1, the color image is transferred from the surface of the intermediate transfer belt 10 to the paper 80 by a second transferring process, which is performed between the second transfer backup roller 70 and the second transfer roller 75.

FIG. 2 is a cross-section view showing the intermediate transfer belt 10. Referring to FIG. 2, the intermediate transfer belt 10 is comprised of a coating layer 11, a urethane rubber layer 12, and a base layer 13. The urethane rubber layer 12 and the base layer 13 contribute to the improved durability of the intermediate transfer belt 10, and the coating layer 11 contributes to the gain of a vivid color image. The first transfer rollers 30, 40, 50, 60 and the OPCs 35, 45, 55, 65 are in close contact with upper and lower surface of the intermediate transfer belt 10, respectively, to transfer color toners to the intermediate transfer belt 10. For this, a transfer voltage is supplied between the first transfer rollers 30, 40, 50, 60 and the OPCs 35, 45, 55, 65 to transfer the color toners to the intermediate transfer belt 10. In this case, a potential difference of approximately 500V to 600V is generated on the upper and lower surfaces of the intermediate transfer belt 10. When the first transferring process is completed, the transfer voltage is stopped. Thus, the potential difference on the upper and lower surfaces of the intermediate transfer belt 10 disappears in a normal case, that is, when no transfer process is occurring.

However, as the number of printed copies increases, electric charges existing in the urethane rubber layer 12 of the intermediate transfer belt 10 do not recombine to each other, which is referred to as a polarization effect. As shown in FIG. 2, the negative (−) electric charge in the urethane rubber layer 12 is aligned along a boundary “a” between the urethane rubber layer 12 and the coating layer 11, whereas the positive (+) electric charge is aligned along a boundary “b” between the urethane rubber layer 12 and the base layer 13. Therefore, although the transfer voltage is not supplied, a predetermined potential difference Vp is still generated in the upper and lower surfaces of the intermediate transfer belt 10. As a result of the polarization, a resistance of the intermediate transfer belt 10 increases.

FIGS. 3A and 3B are graphs explaining the polarization effect and the increase of the resistance which are caused as the number of printed copies increases. In detail, FIG. 3A is a graph showing a variation of a voltage measured at opposite ends of the intermediate transfer belt 10. FIG. 3A shows a first curve 310 indicating a variation of a voltage measured in an initial state of the image forming apparatus, and a second curve 320 indicating a variation of a voltage measured after the image forming apparatus outputs 5000 or more copies. According to the first curve 310, when a transfer voltage of 500V is stopped, a potential difference generated on opposite surfaces of the intermediate transfer belt 10 abruptly decreases to 0V. According to the second curve 320, although the transfer voltage of 500V is stopped, a potential difference of approximately 200V remains. A predetermined voltage still remains on the intermediate transfer belt 10 due to the polarization. Accordingly, if a transfer voltage having the same level as in the initial state is supplied, the transferring process is not normally performed.

FIG. 3B is a graph showing a relationship between a resistance and the number of printed copies. Referring to FIG. 3B, the intermediate transfer belt 10 has a resistance of approximately 25MΩ in an initial state. However, at the time of printing of thirty thousand copies, the resistance increases to 337MΩ, and at the time of printing of fifty thousand copies, the resistance increases to 474MΩ. When the resistance abruptly increases, the level of the transfer voltage must increase to maintain a transfer quality. As the transfer voltage increases, the polarization becomes more significant, and thus the resistance of the intermediate transfer belt 10 increases more rapidly. As a result, a lifespan of the intermediate transfer belt 10 is reduced, and power consumption increases.

Although the level of the transfer voltage increases to compensate for the variation of the resistance, proper conditions for the transferring process may not be present, thereby deteriorating image quality.

A need therefore exists for an image forming apparatus that overcomes the problems associated with polarization of the transfer belt.

### SUMMARY OF THE INVENTION

The present invention has been developed in order to overcome the above-described problems in the related art. Accordingly, an aspect of the present invention is to provide an image forming apparatus which prevents a resistance of an intermediate transfer belt from varying by using a predetermined level of a refresh voltage supplied to the intermediate transfer belt, thereby maintaining an optimal condition for transferring, and a method thereof.

The above exemplary aspect is achieved by providing an image forming apparatus for performing a printing job using an intermediate transfer belt. The image forming apparatus comprises a refresh voltage determination part for determining a predetermined level of a refresh voltage corresponding to a potential difference which is generated on opposite surfaces of the intermediate transfer belt, and a power supply for supplying the refresh voltage to the intermediate transfer belt so that the potential difference is offset.

In accordance with another aspect of the present invention, the illustrative image forming apparatus may further comprise at least one OPC, at least one first transfer roller for transferring a toner image developed on the at least one OPC to a surface of the intermediate transfer belt, and a second transfer roller for transferring the toner image transferred to the surface of the intermediate transfer belt to a predetermined paper.

In accordance with another aspect of the present invention, the exemplary image forming apparatus may further comprise a resistance measurement part for measuring a resistance of the intermediate transfer belt, and a transfer signal determination part for determining a magnitude of a transfer signal, which is supplied to the first and the second transfer rollers to form an electric field for performing a transferring operation, according to the resistance of the intermediate transfer belt.

In accordance with another aspect of the present invention, the exemplary refresh voltage determination part may determine a level of the refresh voltage according to the magnitude of the transfer signal determined by the transfer signal determination part. The refresh voltage determination part increases the level of the refresh voltage if the magnitude of the transfer signal determined by the transfer signal determination part increases, and decreases the level of the refresh voltage if the magnitude of the transfer signal determined by the transfer determination part decreases.

In accordance with another aspect of the present invention, the exemplary image forming apparatus may further comprise a memory for storing information about the refresh voltage corresponding to the magnitude of the transfer signal. In this case, the refresh voltage determination part reads out from the memory the refresh voltage corresponding to the transfer signal determined by the transfer signal determination part.

In accordance with another aspect of the present invention, the exemplary image forming apparatus may further comprise a roller being supplied with the refresh voltage from the power supply and transmitting the refresh voltage to the intermediate transfer belt.

In accordance with another aspect of the present invention, the exemplary image forming apparatus may further comprise a pre-cleaning roller for removing toners left on a surface of the intermediate transfer belt. In this case, the power supply supplies the refresh voltage to the intermediate transfer belt through one of the pre-cleaning roller, the first transfer roller and the second transfer roller.

According to an exemplary embodiment, a transferring method of an image forming apparatus which performs a transferring operation using an intermediate transfer belt is provided, wherein the method comprises (a) determining a predetermined level of a refresh voltage corresponding to a potential difference which is generated on opposite surfaces of the intermediate transfer belt, and (b) supplying the refresh voltage to the intermediate transfer belt so that the potential difference is offset.

In accordance with another aspect of the present invention, the exemplary method may further comprise measuring a resistance of the intermediate transfer belt; determining a magnitude of a first transfer signal according to the resistance of the intermediate transfer belt, the first transfer signal being supplied to a first transfer roller for transferring a predetermined toner to one surface of the intermediate transfer belt, and determining a magnitude of a second transfer signal according to the resistance of the intermediate transfer belt, the second transfer signal being supplied to a second transfer roller for transferring the toner transferred to the one surface of the intermediate transfer belt to a paper,

In accordance with another aspect of the present invention, the step (a) may determine the level of the refresh voltage according to the magnitude of at least one of the first and the second transfer signals.

The exemplary method may further comprise checking a variation in the magnitude of the transfer signal at predetermined intervals, increasing the level of the refresh voltage if the magnitude of the transfer signal increases, and decreasing the level of the refresh voltage if the magnitude of the transfer signal decreases.

In accordance with another aspect of the present invention, the step (b) may supply the refresh voltage to at least one of a pre-cleaning roller for removing a toner left on a surface of the intermediate transfer belt, the first transfer roller, the second transfer roller, and a predetermined roller being in contact with the intermediate transfer roller so that a potential difference of the intermediate transfer roller is offset.

In accordance with another aspect of the present invention, the step (a) may determine the refresh voltage using a data table on which information about the refresh voltage corresponding to the first transfer signal and the second transfer signal is recorded.

### BRIEF DESCRIPTION OF THE DRAWINGS

These and other exemplary aspects and advantages of the present invention will become apparent and more readily appreciated from the following description of the exemplary embodiments, taken in conjunction with the accompanying drawings, in which:

FIG. 1 is a view showing a conventional image forming apparatus using an intermediate transfer belt;

FIG. 2 is a view showing the intermediate transfer belt of FIG. 1;

FIGS. 3A and 3B are graphs showing variations in a resistance value caused by polarization;

FIG. 4 is a block diagram showing an image forming apparatus according to an embodiment of the present invention;

FIG. 5 is a cross-sectional schematic view showing a transferring unit used in the image forming apparatus of FIG. 4;

FIG. 6 is a graph showing a relationship between a refresh voltage and a resistance value according to an embodiment of the present invention;

FIG. 7 is a flowchart showing a transferring method of an image forming apparatus according to an embodiment of the present invention;

FIG. 8 is a flowchart showing a method of determining a reference refresh voltage according to an embodiment of the present invention;

FIG. 9 is a flowchart showing a transferring method of an image forming apparatus according to another embodiment of the present invention; and

FIG. 10 is graph showing a resistance of an intermediate transfer belt used in the image forming apparatus according to an embodiment of the present invention.

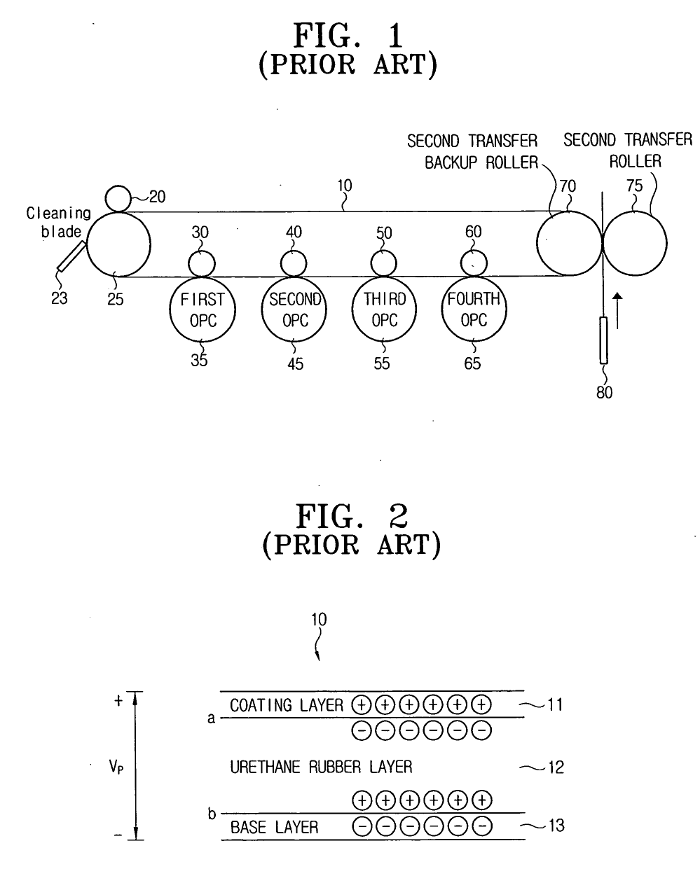

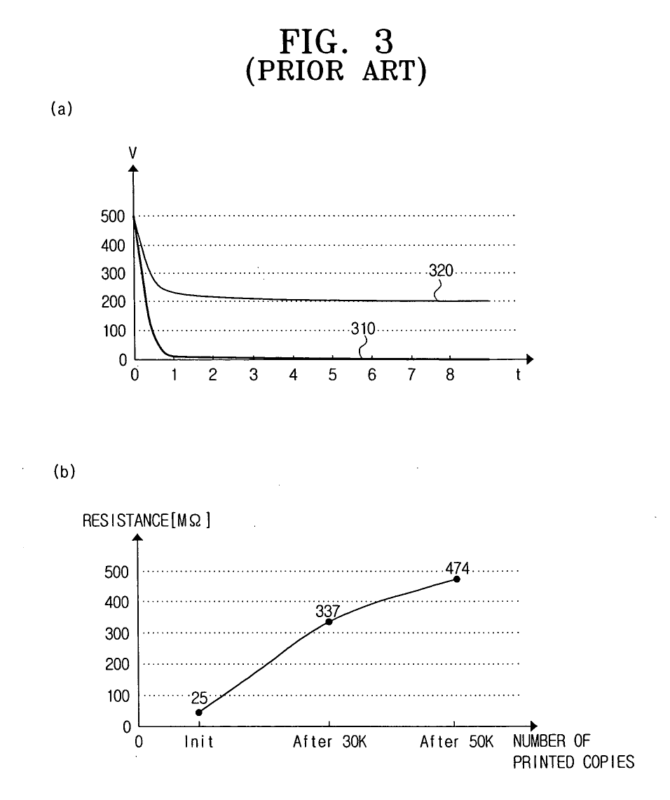

Throughout the drawings, like reference numerals will be understood to refer to like parts, components and structures.

### DETAILED DESCRIPTION OF EXEMPLARY EMBODIMENTS

The present invention will now be described in greater detail with reference to the accompanying drawings.

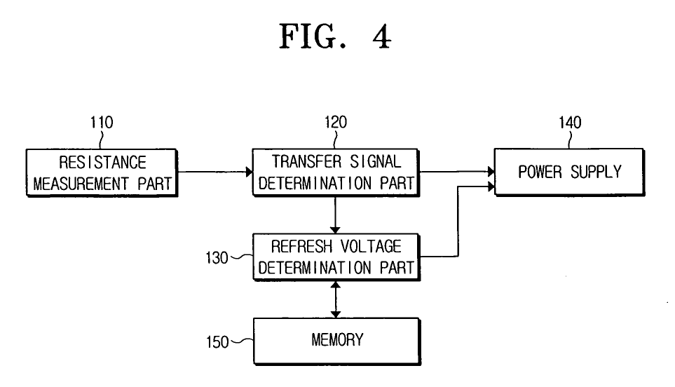

FIG. 4 is a block diagram showing an image forming apparatus according to an embodiment of the present invention. Referring to FIG. 4, the image forming apparatus according to the present invention comprises a resistance measurement part 110, a transfer signal determination part 120, a refresh voltage determination part 130, a power supply 140, and a memory 150.

The resistance measurement part 110 measures a resistance of an intermediate transfer belt (ITB) used in the image forming apparatus. More specifically, the resistance measuring part 110 supplies a test voltage V_{T} between a first transfer roller and an OPC which are in close contact with the ITB or between a second transfer roller and a second transfer backup roller, and detects an electrical value, thereby measuring the resistance of the ITB.

The transfer signal determination part 120 supplies the first and the second transfer rollers with a transfer signal having a magnitude corresponding to the resistance measured by the resistance measurement part 110. The transfer signal is a transfer voltage or a transfer current according to a driving method.

The power supply 140 supplies the first and the second transfer rollers with the transfer voltage or the transfer current determined by the transfer signal determination part 120.

The refresh voltage determination part 130 determines a level of a refresh voltage according to the magnitude of the transfer signal determined by the transfer signal determination part 120. The resistance of the ITB varies depending on a potential difference generated in the ITB due to a polarization. Accordingly, the magnitude of the transfer signal determined by the transfer signal determination part 120 varies depending on the potential difference generated in the ITB. The potential difference increases during a prolonged use of the image forming apparatus, i.e., as the number of printed copies increases. The refresh voltage determination part 130 determines the level of the refresh voltage so that the potential difference is offset by the refresh voltage. As a result, the resistance of the ITB can be essentially constantly maintained. In this case, the level of the refresh voltage is adjusted by checking variations of the transfer signal.

The refresh voltage may use only a DC voltage or may use both an AC voltage having a predetermined amplitude and a predetermined frequency and a DC offset. If the refresh voltage uses only the DC voltage, the refresh voltage can be easily applied to the image forming apparatus. On the other hand, if the refresh voltage is an AC voltage having a DC offset level, a remarkable effect of the refresh voltage can be obtained. The two types of refresh voltage are selectively used according to characteristics of apparatus. If the AC refresh voltage having a DC offset level is used, it is preferable that a maximum amplitude of the AC voltage plus the DC offset does not exceed a set level of a second transfer voltage to obtain a normal image.

In order to determine an optimal level of a refresh voltage according to the magnitude of the transfer signal, a predetermined equation is used. A method of calculating the optimal level of the refresh voltage will be described below.

The power supply 140 supplies the ITB with the level of the refresh voltage determined by the refresh voltage determination part 130 so that the potential difference can be offset by the refresh voltage, and thus, the resistance is essentially: constantly maintained. At this time, the refresh voltage is supplied in a direction which is opposite to a supply direction of the transfer signal. Also, the refresh voltage is supplied through a predetermined roller which is in contact with the ITB. The predetermined roller may be a pre-cleaning roller, a first transfer roller or a second transfer roller. Alternatively, a roller dedicated to the supply of refresh voltage may be further provided. If the first and the second transfer rollers are used to supply the refresh voltage, the refresh voltage is supplied during a pause period, i.e., when a transferring process is stopped. In other words, the refresh voltage is supplied in the direction opposite the supply direction of the transfer voltage to offset the potential difference.

However, if the first roller and the second roller are used to supply the refresh voltage, the effect of the refresh voltage deteriorates because the refresh voltage is supplied only during the pause period. Also, if the dedicated roller is additionally provided, a cost-saving effect or a space-utilizing effect cannot be achieved. In view of these points, it is preferable to use the pre-cleaning roller.

According to another embodiment, the refresh voltage determination part 130 does not calculate the refresh voltage, but instead reads out a proper refresh voltage from a data table stored in the memory. That is, the level of the refresh voltage is determined based on a transfer signal and a level of a refresh voltage corresponding to the transfer signal which were previously stored in the memory 150. Therefore, the calculation load of the refresh voltage determination part 130 can be reduced.

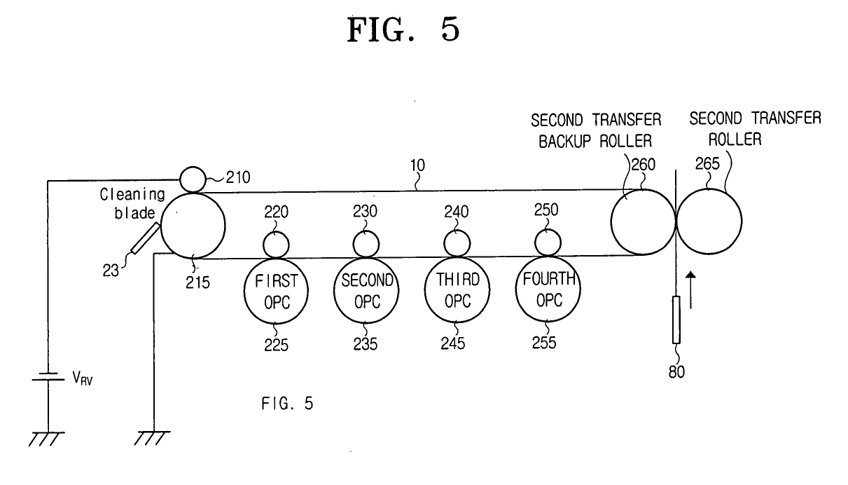

FIG. 5 is a view showing an ITB 10 and a transfer unit which are used in the image forming apparatus according to an embodiment of the present invention. In this embodiment, the exemplary transfer unit for a transferring process includes four first transfer rollers, four OPCs, a second transfer roller, and a second transfer backup roller.

Referring to FIG. 5, a driving roller 215, a plurality of first transfer rollers 220, 230, 240, 250, and a second transfer backup roller 260 are arranged in contact with an inner surface of the ITB 10. Meanwhile, a pre-cleaning roller 210, a plurality of OPCs 225, 235, 245, 255, and a second transfer roller 265 are arranged in contact with an outer surface of the ITB 10. The ITB is comprised of a plurality of material layers. More specifically, the ITB is comprised of a base layer, an intermediate layer, and an uppermost layer. The base layer uses a material that is robust against a tension which may be applied during an operation of the ITB. The intermediate layer uses a soft material that is deformable according to a characteristic of a paper surface to smoothly transfer toners on the ITB to paper. The uppermost layer uses a hard material that can withstand the angled abutment of a cleaning blade for removing toner left after the transferring process. By way of an example, the transfer signal for forming an electric field on the transfer roller is supplied in the form of voltage.

The driving roller 215 moves the ITB 10 in a predetermined direction. The plurality of first transfer rollers 220, 230, 240, 250 perform a first transferring process so that toner formed on surfaces of the OPCs 225, 235, 245, 255 corresponding to the plurality of first transfer rollers 220, 230, 240, 250 are transferred to the ITB 10. For this, a first transfer voltage is supplied from the power supply 140. Although in this embodiment, four first transfer rollers 220, 230, 240, 250 are provided, the number of first transfer rollers is different depending on the kind of the image forming apparatus.

The second transfer roller 265 performs a second transfer process in cooperation with the second transfer backup roller 260 so that the toner transferred to the ITB 10 through the first transferring process is transferred to a paper 80. For this, a second transfer voltage is supplied from the power supply 140.

The refresh voltage determination part 130 determines the level of refresh voltage based on the level of the second transfer voltage supplied to the second transfer roller 265 using to the following Equation 1.

$${V}_{RV} = \frac{{V}_{T 2}}{2} \qquad [ Equation 1 ]$$

wherein V_{RV} denotes a refresh voltage and V_{T2} denotes a second transfer voltage. The refresh voltage obtained by the Equation 1 is referred to as a reference refresh voltage and is supplied to the ITB 10 so that the potential difference formed on the ITB 10 is offset by the refresh voltage.

The refresh voltage determination part 130 determines a level of the first transfer voltage supplied to the first transfer roller during the printing process and adjusts the level of the refresh voltage using the following Equation 2.
V_{RV}=V_{old-RV} (at V_{T1}=V_{old-T1})
V_{RV}=V_{old-RV}−K(V_{T1}−V_{old-T1}) (at V_{T1}<V_{old-T1})
V_{RV}=V_{old-RV}+K(V_{T1}−V_{old-T1}) (at V_{T1}>V_{old-T1}) [Equation 2]

wherein V_{T1} denotes a first transfer voltage, V_{old-T1} denotes a previous first transfer voltage, V_{RV} denotes a refresh voltage, V_{old-RV} denotes a previous refresh voltage, and K denotes a proportional constant. K is arbitrarily set in a range so that the maximum refresh voltage does not exceed a transfer voltage T2. For example, K is set to ‘2’.If the first transfer voltage is identical to the previous first transfer voltage, the refresh voltage is maintained, and if the first transfer voltage is less than the previous first transfer voltage, the refresh voltage is decreased. If the first transfer voltage is greater than the previous first transfer voltage, the refresh voltage is increased. The adjust amount is determined depending on the number of the first transfer rollers 220, 230, 240 and 250. In Equation 2, if K is ‘2’, a value obtained by multiplying a variation amount of the transfer voltage by 2 is the adjustment amount of the refresh voltage.

The power supply 140 supplies the refresh voltage V_{RV} determined by the refresh voltage determination part 130 to the ITB 10. As shown in FIG. 5, the refresh voltage V_{RV} is supplied to the pre-cleaning roller 210 such that the driving roller 215 is grounded. Consequently, the refresh voltage V_{RV} is supplied in a direction which is opposite to a direction of the potential difference formed on the ITB so the potential difference is offset by the refresh voltage, and thus, the resistance of the ITB can be constantly maintained.

The power supply 140 may supply the refresh voltage through one of the first transfer rollers 225, 235, 245, 255 or the second transfer roller 265 instead of the pre-cleaning roller 210. Alternatively, it is possible that the refresh voltage is supplied through an extra roller (not shown).

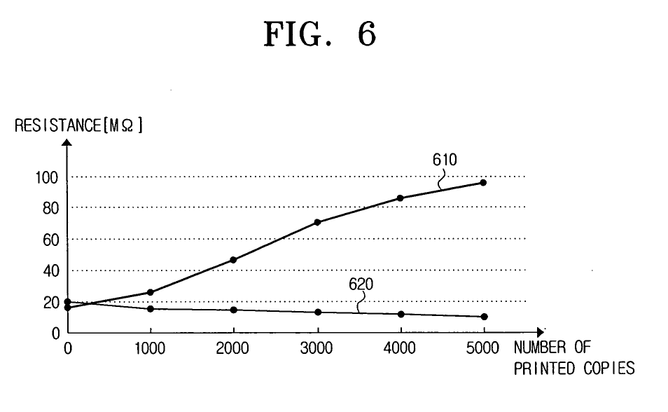

FIG. 6 is a graph showing a relationship between the resistance and the number of printed copies when a predetermined level of refresh voltage is supplied. In FIG. 6, a curve 610 indicates a relationship between the resistance and the number of printed copies if the refresh voltage of 1 kV is supplied, and a curve 620 indicates a relationship between the resistance and the number of printed copies if the refresh voltage of 2 kV is supplied. As shown in FIG. 6, if 1 kV is supplied, the resistance increases as the number of printed copies increases. In other word, the potential difference of the ITB is not completely offset by the refresh voltage of 1 kV. On the other hand, if the refresh voltage of 2 kV is supplied, the resistance decreases as the number of printed copies increases. In other words, the refresh voltage of 2 kB has a greater value than the potential difference of the ITB 10. Subsequently, the ITB 10 is subjected to a predetermined level of a reverse voltage and, in order to maintain an appropriate condition, the transfer voltage has to be reduced. However, in this case, image quality deteriorates since the appropriate condition for transferring cannot be satisfied.

Therefore, the refresh voltage determination 130 adjusts the level of the refresh voltage according to the variations of the resistance. That is, in order to maintain the resistance constant, the refresh voltage is adjusted to a value ranging from 1 kV to 2 kV.

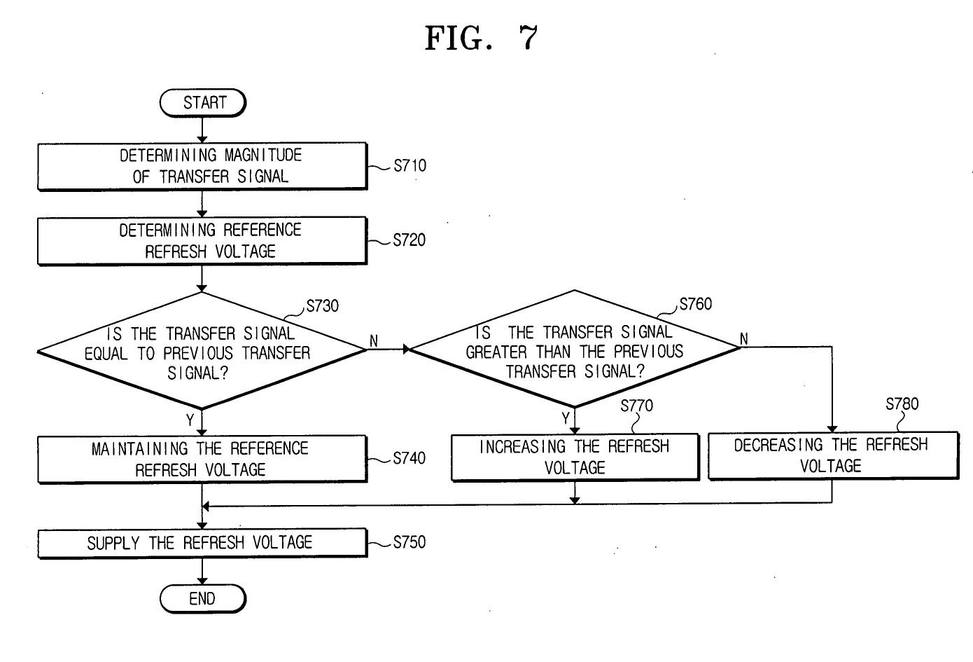

FIG. 7 is a flowchart illustrating a transferring method of the image forming apparatus according to an embodiment of the present invention. Referring to FIG. 7, a magnitude of a transfer signal (i.e., a transfer voltage or transfer current) is recognized at step S710. The level of the transfer voltage or transfer current supplied to a first transfer roller or a second transfer roller is determined according to the resistance.

Next, a reference refresh voltage is set at step S720. The reference refresh voltage may be set according to the determined level of transfer voltage. Alternatively, the reference refresh voltage is a default voltage stored in the memory 150.

At step S730, it is determined whether the determined magnitude of transfer signal is identical to a previous transfer signal (i.e., whether there is a change in the transfer signal).

If the determined magnitude of the transfer signal is identical to the previous transfer signal, the reference refresh voltage is maintained at step S740 and supplied to the ITB 10 at step S750.

If the transfer signal is greater than the previous transfer signal at step S760, the refresh voltage is increased at step S770, and then is supplied to the ITB 10 at step S750.

If the transfer signal is less than the previous transfer signal at step S760, the refresh voltage is decreased at step S780 and then is supplied to the ITB 10 at step S750. Accordingly, the resistance of the ITB 10 is prevented from varying so that a normal transferring process can be performed.

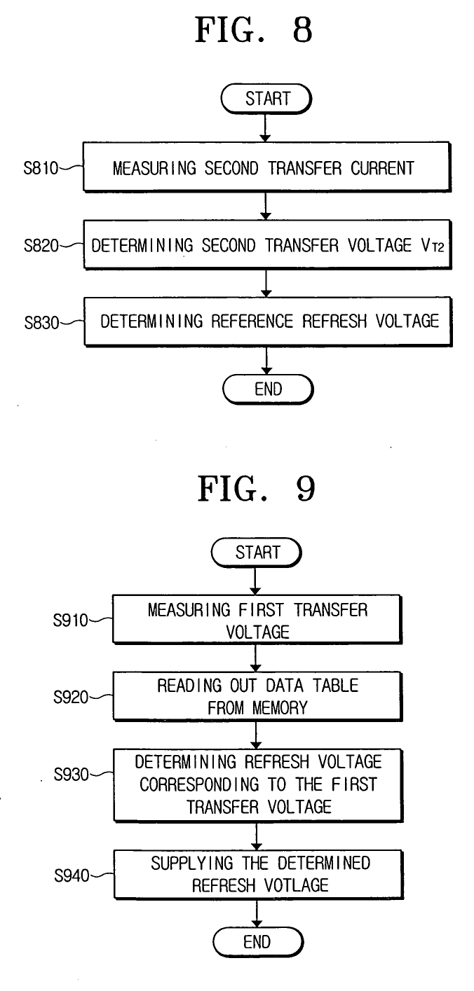

FIG. 8 is a flowchart showing a method of setting the reference refresh voltage in detail. Referring to FIG. 8, a second transfer current flowing through the second transfer roller 265 and the second transfer backup roller 260 is measured at step S810. A second transfer voltage is determined according to the measured second transfer current at step S820. In this case, the second transfer voltage is determined based on the second transfer current and a proper second transfer voltage corresponding to the second transfer current which are stored in the memory 150 in the form of a data table, for example.

The reference refresh voltage is determined by dividing the second transfer voltage by 2 at step S830.

FIG. 9 is a flowchart showing a transferring method of an image forming apparatus according to another embodiment. Referring to FIG. 9, a first transfer voltage being supplied to a first transfer roller is determined at step S910. A data table is read out from a memory 150 at step S920, and a refresh voltage is determined according to the first transfer voltage at step S930. For this, the first transfer voltage and the refresh voltage corresponding to the first transfer voltage are previously stored in the memory 150. The determined refresh voltage is supplied to an ITB 10 at step S940.

Since a potential difference generated on the ITB 10 is offset by the refresh voltage, a resistance can be essentially constantly maintained.

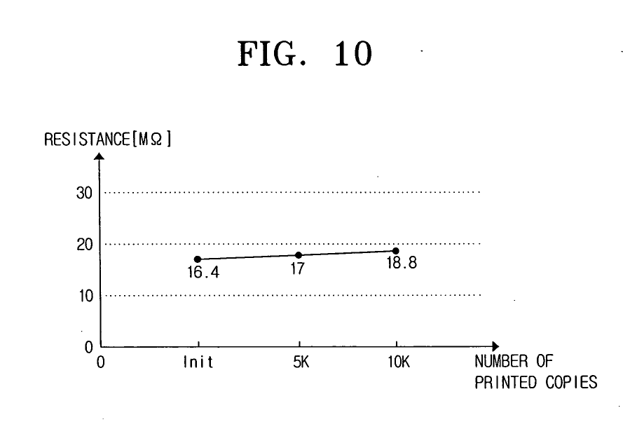

FIG. 10 is a graph showing a relationship between a resistance of the ITB 10 and the number of printed copies of the image forming apparatus according to the present invention. Referring to FIG. 10, a resistance of approximately 16.4 MΩ is measured at an initial state. When the number of printed copies is 5000, the resistance increments to 17 MΩ, and when the number of printed copies approaches is 10000, the resistance increments to 18.8 MΩ. According to the graph of FIG. 10, although the number of printed copies increases, the amount by which the resistance increments is small.

According to the present invention, the refresh voltage is supplied to the ITB 10 so that the potential difference generated on the opposite surfaces of the ITB 10 is offset by the refresh voltage. Accordingly, the resistance is prevented from being increased due to the potential difference, and thus unnecessary power consumption can be prevented. Also, the lifespan of the ITB can be extended, and the optimal conditions for printing can be satisfied although the number of printed copies increases.

The foregoing embodiment and advantages are merely exemplary and are not to be construed as limiting the present invention. The description of the present invention is intended to be illustrative, and not to limit the scope of the claims. Many alternatives, modifications, and variations will be apparent to those skilled in the art.

What is claimed is:

1. An image forming apparatus for performing a printing job using an intermediate transfer belt, the apparatus comprising:
a refresh voltage determination part for determining a level of a refresh voltage corresponding to a potential difference which is generated on opposite surfaces of the intermediate transfer belt; and
a power supply for supplying the refresh voltage to the intermediate transfer belt so that the potential difference is offset.

2. The image forming apparatus as claimed in claim 1, further comprising:
at least one organic photoconductor (OPC);
at least one first transfer roller for transferring a toner image developed on the at least one OPC to a surface of the intermediate transfer belt; and
a second transfer roller for transferring the toner image transferred to the surface of the intermediate transfer belt to a paper.

3. The image forming apparatus as claimed in claim 2, further comprising:
a resistance measurement part for measuring a resistance of the intermediate transfer belt; and
a transfer signal determination part for determining a magnitude of a transfer signal, which is supplied to the first transfer roller and the second transfer roller to form an electric field for performing a transferring operation, according to the resistance of the intermediate transfer belt.

4. The image forming apparatus as claimed in claim 3, wherein the refresh voltage determination part determines a level of the refresh voltage according to the magnitude of the transfer signal determined by the transfer signal determination part.

5. The image forming apparatus as claimed in claim 4, wherein the refresh voltage determination part, if the transfer signal is a transfer voltage, determines the level of the refresh voltage using the following equation:
$${V}_{RV} = \frac{{V}_{T 2}}{2}$$
wherein V_{RV} denotes the level of the refresh voltage and V_{T2} denotes a transfer voltage supplied to the second transfer roller.

6. The image forming apparatus as claimed in claim 4, wherein the refresh voltage determination part increases the level of the refresh voltage if the magnitude of the transfer signal determined by the transfer signal determination part increases, and decreases the level of the refresh voltage if the magnitude of the transfer signal determined by the transfer signal determination part decreases.

7. The image forming apparatus as claimed in claim 6, wherein the refresh voltage determination part adjusts the level of the refresh voltage using the following equation:
V_{RV}=V_{old-RV} (at V_{T1}=V_{old-T1})
V_{RV}=V_{old-RV}−K(V_{T1}−V_{old-T1}) (at V_{T1}<V_{old-T1})
V_{RV}=V_{old-RV}+K(V_{T1}−V_{old-T1}) (at V_{Ti}>V_{old-T1}) [Equation 2]
wherein V_{T1} denotes a transfer voltage supplied to the first transfer roller, V_{old-T1} denotes a previous transfer voltage supplied to the first transfer roller, V_{RV} denotes the refresh voltage, V_{old-RV} denotes a previous refresh voltage, K denotes a proportional constant.

8. The image forming apparatus as claimed in claim 1, further comprising a roller being supplied with the refresh voltage from the power supply and transmitting the refresh voltage to the intermediate transfer belt.

9. The image forming apparatus as claimed in claim 3, further comprising a pre-cleaning roller for removing toners left on a surface of the intermediate transfer belt, wherein the power supply supplies the refresh voltage to the intermediate transfer belt through one of the pre-cleaning roller, the first transfer roller and the second transfer roller, and a predetermined roller being in contact with the intermediate transfer belt so that a potential difference of the intermediate transfer belt is offset.

10. The image forming apparatus as claimed in claim 3, further comprising a memory for storing information about the refresh voltage corresponding to the magnitude of the transfer signal,
wherein the refresh voltage determination part reads out from the memory the refresh voltage corresponding to the transfer signal determined by the transfer signal determination part.

11. A transferring method of an image forming apparatus which performs a transferring operation using an intermediate transfer belt, the method comprising:
(a) determining a predetermined level of a refresh voltage corresponding to a potential difference which is generated on opposite surfaces of the intermediate transfer belt; and
(b) supplying the refresh voltage to the intermediate transfer belt so that the potential difference is offset.

12. The method as claimed in claim 11, further comprising:
measuring a resistance of the intermediate transfer belt;
determining a magnitude of a first transfer signal according to the resistance of the intermediate transfer belt, the first transfer signal being supplied to a first transfer roller for transferring a predetermined toner to a surface of the intermediate transfer belt; and
determining a magnitude of a second transfer signal according to the resistance of the intermediate transfer belt, the second transfer signal being supplied to a second transfer roller for transferring the toner transferred to the surface of the intermediate transfer belt to a paper.

13. The method as claimed in claim 12, wherein the step (a) determines the level of the refresh voltage according to the magnitude of at least one of the first and the second transfer signals.

14. The method as claimed in claim 13, further comprising:
determining if a variation in the magnitude of the transfer signal has occurred at predetermined intervals;
increasing the level of the refresh voltage if the magnitude of the transfer signal increases; and
decreasing the level of the refresh voltage if the magnitude of the transfer signal decreases.

15. The method as claimed in claim 13, wherein the step (b) supplies the refresh voltage to at least one of a pre-cleaning roller for removing a toner left on a surface of the intermediate transfer belt, the first transfer roller, the second transfer roller and a predetermined roller being in contact with the intermediate transfer belt so the a potential difference of the intermediate transfer belt is offset.

16. The method as claimed in claim 13, wherein the step (a) determines the refresh voltage using a data table on which information about the refresh voltage corresponding to the first transfer signal and the second transfer signal is recorded.
